(19) United States
(12) Patent Application Publication
(10) Pub. No.: US 2004/0142722 A1
(43) Pub. Date: Jul. 22, 2004

(54) Databus communicator within a telemetry system

(76) Inventor: Gregory J. Everett, Warren, MI (US)

Correspondence Address: IRVING M. WEINER, WEINER & BURT, P.C., 635 N. US-23, P.O. BOX 186, HARRISVILLE, MI, 48740, US

(21) Appl. No.: 10/754,866

(22) Filed: Jan. 9, 2004

Related U.S. Application Data
(60) Provisional application No. 60/439,158, filed on Jan. 10, 2003.

(51) Int. Cl. H04M 1/00

(52) U.S. Cl. 455/550.1

(57) ABSTRACT

A databus communicator that uses a CAN system protocol between a stationary module and a vehicle, in combination with a wireless control device: which allows communication, commands, and readings to be sent via telephone, Internet, e-mail, or any text-compatible device or network; is capable of sending, receiving, and transferring data via a wireless satellite, and paging network; can activate circuits via wireless commands, and send data upon request showing the status of any pre-programmed device; acts as a gateway between the wireless network and the circuit it is programmed to command, read, or communicate with; is capable of sending data in any format; is able to be pre-programmed to activate circuitry, global positioning coordinates, take specific readings and can be programmed and configured; can use over the air programming to allow configuration of any device using the wireless network to transfer programming data; uses existing wireless service providers to access the network; may include a network roam module which looks for network strength and switches networks based on signal strength and may include a micro controller operably connected to a GPS receiver and to a satellite transmitter.

The present patent application claims priority from and is based on U.S. Provisional Patent Application Serial No. 60/439,158 filed on Jan. 10, 2003, which in turn claims priority from and is a continuation-in-part of U.S. Provisional Patent Application Serial No. 60/404,335, filed Aug. 21, 2002, entitled “WIRELESS CONTROL SYSTEM FOR MULTIPLE NETWORKS”, the entire contents of which are incorporated herein by reference thereto.

The present relates generally to a databus communicator for use in a wireless device and a control system which uses multiple networks to send and receive data.

Particularly, the present invention relates to a CAN databus communicator which operates with a wireless device and control system which allows communication, commands and readings to be sent via telephone, Internet, e-mail, radio communication, or any text-compatible device or network.

The term “CAN” as used herein means Controller Area Network.

### BACKGROUND OF THE INVENTION

The relevant art is exemplified by the following United States patents.

Salazar et al U.S. Pat. No. 5,802,467, entitled “WIRELESS AND WIRED COMMUNICATIONS, COMMAND, CONTROL AND SENSING SYSTEM FOR SOUND AND/OR DATA TRANSMISSION AND RECEPTION”, discloses an interactive microprocessor based wireless communication device which includes sound and data transceivers, signal detection and coupling devices, signal conversion device, voice recording, playback and storage devices, voice activated devices, display devices, touch screen or similar devices, sensors, frequency generation devices, sound detection and reproduction devices, and power sources to concurrently perform generalized two-way wireless communications, command, control and sensing function utilizing radio and infra-red frequency communication links.

Byrd et al U.S. Pat. No. 6,049,269, entitled “WIDE AREA WIRELESS SYSTEM FOR ACCESS INTO VEHICLES AND FLEETS FOR CONTROL, SECURITY, MESSAGING, REPORTING AND TRACKING, discloses an add-on vehicular system capable of responding to large area or nation-wide commands over paging networks, to remotely foil the unauthorized use or theft of a vehicle or a fleet automobile or a group of fleet vehicles, as well as to help the recovery of stolen vehicles.

Chittipeddi U.S. Pat. 6,246,325, entitled “DISTRIBUTED COMMUNICATIONS SYSTEM FOR REDUCING EQUIPMENT DOWN-TIME”, discloses a method to more efficiently exchange information between a service provider, such as a semiconductor company, and its remote equipment units. The system includes a central controller configured for interfacing with a plurality of remote equipment units via a wireless network.

It is a desideratum of the present invention to avoid the animadversions of conventional and prior devices and systems.

### SUMMARY OF THE INVENTION

The present invention provides a CAN communicator to control, diagnose, and evaluate system operations in automotive applications.

The present invention provides a databus communicator which uses a Controller Area Network system communication protocol between a stationary module and a vehicle, comprising, in combination: a wireless control device for multiple networks which allows communication, commands, and readings to be sent and received via telephone, internet, e-mail, or any text-compatible device or network; a main circuit board/two-way paging device; said databus communicator being operably connected to said main circuit board/two-way paging device; a two-way paging antenna operably connected to said main circuit board/two-way paging device; a satellite modem/satellite communication circuit board operably connected to said main circuit board/two-way paging device; a satellite antenna operably connected to said satellite modem/satellite communication circuit board; a global positioning chip set operably connected to said main circuit board/two-way paging device; a global positioning antenna operably connected to said global positioning chip set; a voltage regulation circuit board operably connected to said main circuit board/two-way paging device; a microprocessor board/network carrier roam control unit operably connected to said main circuit board/two-way paging device; first means for determining the best way to send data over various network types, such as two-way paging, one-way paging, CDMA, GSM, TDMA, satellite, or analog.

The present invention also provides a databus communicator which uses a Controller Area Network system communication protocol between a stationary module and a vehicle, comprising, in combination: a wireless control device for multiple networks which allows communication, commands, and readings to be sent and received via telephone, internet, e-mail or any text-compatible device or network; a motherboard having a dataport; a network roam module operably connected to said dataport or said motherboard; a plurality of chip sets, including CDMA, TDMA, GSM, and analog cellular operably connected to said network roam module; a satellite modem operably connected to said dataport; a satellite antenna operably connected to said satellite modem; network antennas, operably connected to said dataport; a GPS chip set operably connected to said motherboard; a GPS antenna operably connected to said GPS chip set; said databus communicator being operably connected to said motherboard; an external voltage regulating circuit operably connected to said motherboard; an external flash memory and microprocessor operably connected to said motherboard; and means for determining the best way to send data over a plurality of network types including two-way paging, one-way paging, CDMA, GSM, TDMA, satellite or analog.

The present invention also provides a databus communicator which uses a Controller Area Network system communication protocol between a stationary module and a vehicle, comprising, in combination: a wireless control device for tracking said vehicle; a GPS receiver; a satellite transmitter operably connected to said GPS receiver for transmitting data from said vehicle through satellites; a microcontroller operably connected to said GPS receiver and to said satellite transmitter; a source of electrical power operably connected to said GPS receiver, said satellite transmitter, and said microcontroller; said database communicator being operably connected with said microcontroller; attachment means for installing said wireless control device on said vehicle; first means for sensing predetermined conditions relating to said vehicle; and said first means being operably connected to said satellite transmitter and said microcontroller.

The present invention further provides a wireless device and a wireless control system using a CAN databus communicator which allows communication, commands, and readings to be sent via telephone, Internet, e-mail, and any text-compatible device or network.

An object of the present invention is to provide such a novel device which is capable of sending, receiving and transferring data via a wireless satellite and paging network.

Another object of the present invention is to provide such a novel device which can activate circuits via wireless command, and send data upon request showing the status of a pre-programmed device.

A further object is to provide such a novel device which acts as a gateway between the wireless networks and the circuit it is programmed to command, read or communicate with.

Yet another object is to provide such a novel device which is capable of sending data in any format.

It is another object of the present invention to be able to guide a vehicle (auto-pilot) along the interstate highways using the system for data transfer in accordance with the present invention. In such a system, an individual can input his/her destination, and the system (via software programming) will be able to steer, brake, accelerate the vehicle automatically, while inputting and analyzing data from the vehicle's electronic control module as to the condition of the vehicle's mechanical and electrical functions.

Data from the vehicle can be sent via telephone, pager, e-mail, as to current status and history of vehicle systems such as air bag deployment, fuel level, temperature, etc., any sensors that currently give vehicle status to the driver or the electronic control module as well as any future sensors, such as low tire inflation status, which is now being considered to be mandated on new vehicles by the U.S. government.

The objects, features and advantages of the present invention will become more apparent to those persons skilled in this particular area of technology and to others after reading the present patent application in conjunction with the accompanying patent drawings.

### BRIEF DESCRIPTION OF THE DRAWINGS

FIG. 1 illustrates a block diagram of a wireless control system in accordance with a first embodiment of the present invention.

FIG. 2 shows a block diagram of a wireless control system in accordance with a second embodiment of the present invention.

FIG. 3 illustrates a CAN connection ISO 11898.

FIG. 4 illustrates the broadcast transmission.

FIGS. 5 and 6 illustrate the non-destructive arbitration.

### DETAILED DESCRIPTION OF THE INVENTION

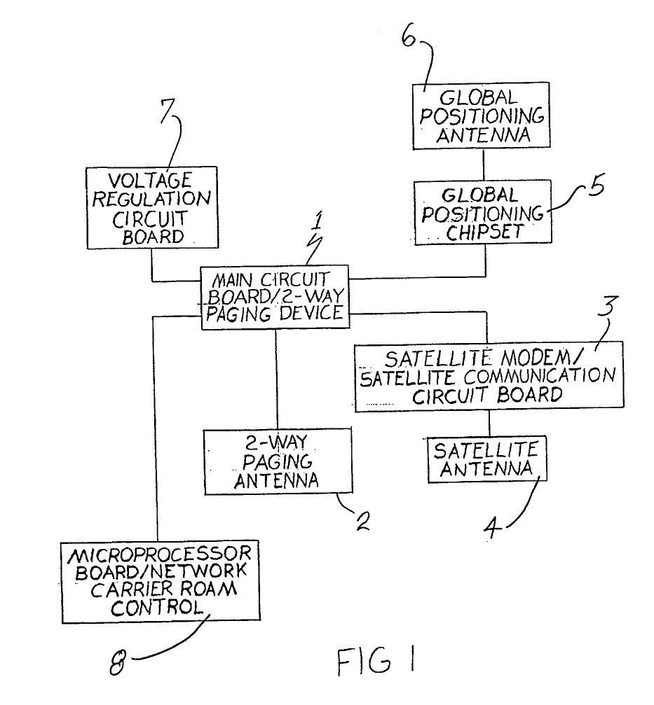

With reference to FIG. 1, there is shown a main circuit board/2-way paging device 1, which is operably connected to a 2-way paging antenna 2

Similarly, a satellite modem/satellite communications circuit board 3 is operably connected to a satellite antenna 4.

There is also provided a global positioning chip set 5, which is operably connected to a global positioning antenna 6.

The system also includes a voltage regulation circuit board 7, which is operably connected to the main circuit board/2-way paging device 1.

The system also includes a microprocessor board/carrier roam control 8, which is operably connected to the main circuit board/2-way paging device 1.

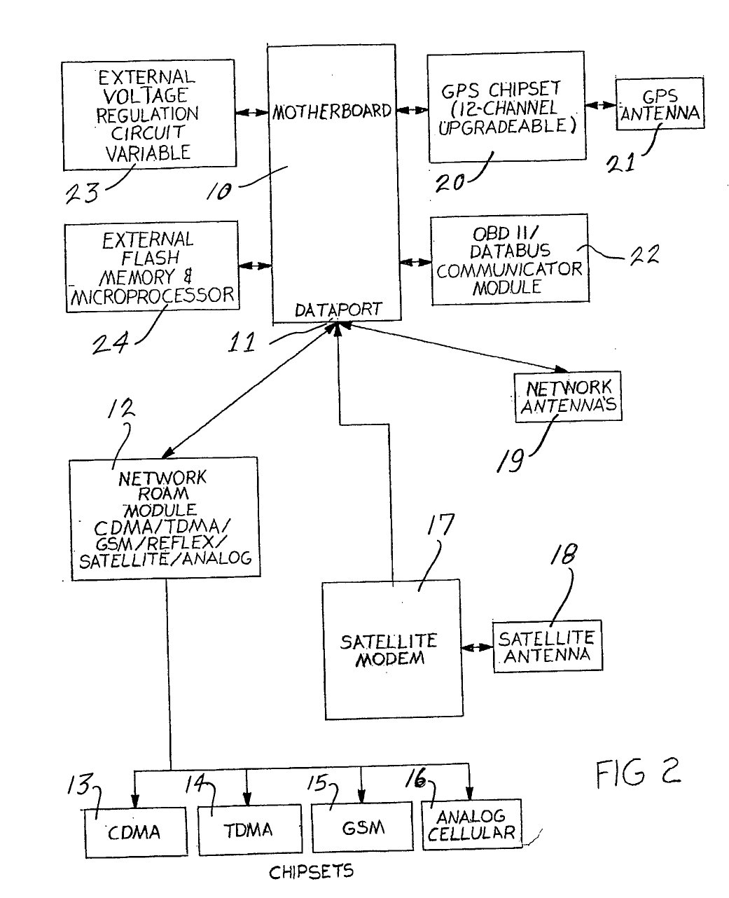

With reference to FIG. 2, there is shown a motherboard 10 including a dataport 11. Preferably, but not necessarily, the motherboard 10 may comprise a Motorola Creatalink 2XT.

The dataport 11 is connected to a network roam module 12 CDMA, TDMA, GSM, Reflex, satellite, analog, which in turn is operably connected to a plurality of chipsets, such as CDMA 13, TDMA 14, GSM 15, and Analog Cellular 16.

CDMA (Code Division Multiple Access) is a “spread spectrum” technology, which means that it spreads the information contained in a particular signal of interest over a much greater bandwidth than the original signal. When implemented in a cellular telephone system, CDMA technology offers numerous benefits to the cellular operators and their subscribers. Such benefits include: capacity increases of 8 to 10 times that of an AMPS analog system; improved call quality with better and more consistent sound as compared to an AMPS system; simplified system planning through the use of the same frequency in every sector of every cell; enhanced privacy; improved coverage characteristics, allowing for the possibility of fewer cell sites; increased talk time for portables; and bandwidth on demand.

TDMA (Time Division Multiple Access) is digital transmission technology which allows a number of users to access a single radio-frequency (RF) channel without interference by allocating unique time slots to each user within each channel. The TDMA digital transmission scheme multiplexes three signals over a single channel. The current RDMA standard for cellular divides a single channel into six time slots, with each channel using two slots, providing a 3 to 1 gain in capacity over advanced mobile-phone service (AMPS). Each caller is assigned a specific time slot for transmission.

The wireless industry began to explore converting the existing analog network to digital as a means of improving capacity back in the late 1980's. In 1989, the Cellular Telecommunications Industry Association (CTIA) chose TDMA over Motorola's frequency division multiple access (FDMA) (today known as narrowband analog mobile-phone service, NAMPS) narrowband standard as the technology of choice for existing 800 MHz cellular markets and for emerging 1.9 GHz markets. With the growing technology competition applied by Qualcomm in favor of code division multiple access (CDMA) and the realities of the European global system for mobile communications (GSM) standard, the CTIA decided to let carriers make their own technologies selection.

The two major (competing) systems that split the RF are TMDA and CDMA. CDMA is a spread-spectrum technology which allows multiple frequencies to be used simultaneously. CDMA codes every digital pack it sends with a unique key. A CDMA receiver responds only to that key, and can pick out and demodulate the associated signal.

Because of its adoption by the European standard GSM, the Japanese Digital Cellular (JDC), and the North American Digital Cellular (NADC), TDMA and its variants are currently the technology of choice throughout the world. However, over the last few years, a debate has convulsed the wireless community over the respective merits of TDMA and CDMA.

The TDMA system is designed for use in a range of environments and situations, from hand portable use in a downtown office to a mobile user traveling at high speed on the freeway.

Referring again to FIG. 2, it is shown that the dataport 11 of the motherboard 10 is operably connected to a satellite modem 17, which in turn is operably connected to a satellite antenna 18. The dataport 11 of the motherboard 10 is also operably connected to network antennas 19.

The motherboard 10 is also operably connected to a 12-channel upgradable GPS chipset 20, which in turn is operably connected to a GPS antenna 21.

The motherboard 10 is also operably connected to an OBD-II/databus communicator module 22.

On-board diagnostic systems are in most cars and light trucks on the road today. During the 1970's and the early 1980's, manufacturers started using electronic means to control engine functions and diagnose engine problems. This was primarily to meet EPA emissions standards. Through the years, on-board diagnostic systems have become more sophisticated. OBD-II. a new standard introduced in the mid 1990's, provides almost complete engine control and also monitors parts of the chassis, body and accessory devices, as well as the diagnostic control network of the vehicle.

The motherboard 10 is operably connected to an external voltage regulation circuit variable 23 and an external flash memory and microprocessor 24.

The present invention provides a wireless device and a wireless control system which allows communication, commands, and readings to be sent via telephone, Internet, e-mail, and any text-compatible device or network. The device is capable of sending, receiving and transferring data via a wireless satellite and paging network. In particular, the present invention provides a CAN communicator to control, diagnose, and evaluate system operations in automotive applications.

The device can activate circuits via wireless command, and send data upon request showing the status of a pre-programmed device. The device acts as a gateway between the wireless networks and the circuit is programmed to command, read or communicate with.

The device is capable of sending data in any format. The device is able to be pre-programmed to activate circuitry, global positioning coordinates, take specific readings, and which can be programmed and configured. The device can use “over the air” programming to allow configuration of a device utilizing the wireless network to transfer programming data. The device uses existing wireless service providers to access the network.

The wireless device and wireless control system in accordance with the present invention utilizes multiple networks to send and receive data. For example, the device can use the following network types based on availability in any given area: two-way paging; one-way paging; CDMA; GSM; TDMA; satellite, analog; etc.

The device looks for the best way to send data. If the device is out of range of the two-way paging network, but a one-way paging network is available, then the device will receive data through the one-way paging network, but will utilize either CDMA, TDMA, GSM, or analog network to send the data. If none of these networks are available, the satellite network will be used to send and receive data. All networks can support two-way data transfer assuming coverage is provided in that particular area.

One of the main points of using multiple networks is to lower the cost of data transfer, but the satellite network is a true global system. It will work anywhere in the world. There is no loss of coverage, even in the middle of the ocean.

The omnipresence of the satellite footprint and the speed of data transfer enables the provision of multi-media access via Internet connection (e-mail, movies, web access, etc., satellite telephone, and the ability to remotely guide vehicles along the roadway with the ability of redundant data transfer, GPS, and drive-by wire data bus configuration in the next generation of automotive vehicles.

The installation and operation of one particular embodiment of the invention is explained below.

The wireless control module may be easily installed using normal hand tools. The module is simply mounted and wired up. After powering the system up, the unit can then be configured using Over the Air programming, or by the use of a serial port (terminal program such as Hyperterminal or Procomm required). After the initial configuration, no changes are necessary.

Alternatively, the module can be shipped pre-configured if desired, so no configuration would be necessary at the site.

Messages can be sent when an exception (such as a transition from a good value to a bad one) occurs. The format of these messages are customizable, depending upon the type and requirements of the message that needs to be sent. When an exception occurs, messages can be sent to up to 3 locations or addresses (e-mail, fax, pager, host, monitoring station). These locations are fully customizable by the user. There are two types of messaging available with the wireless control module: Terse and Verbose. These types are explained in detail below.

Terse messaging can be used on any input (digital or analog) or output. Terse messaging may use the Aloha packet scheme that only sends 1 byte of information. This messaging scheme is designed to save costs. Terse messaging can be sent to email, pager, fax, monitoring software, or host. Typically, terse messaging would be sent to a host or monitoring station, where in can be deciphered into a meaningful message. The following is an example of a terse message when the Input number 2 changes from a Good state to a Bad state:

Example of terse message: 20.

The first digit in the message above corresponds to the Input Number (2 in this case). The second digit corresponds to a Bad State (0=Bad, 1=Good, 2-9 are customizable). Because a terse message is an Aloha style message, it will automatically be placed in a designated mailbox by the Network Operator.

Verbose messaging can be used to provide a more detailed explanation of what has occurred. Verbose messages are customizable by the user to the user's specific messaging requirements. Verbose messages may be up to 50 characters in length. Verbose messages can also be sent to up to 3 locations/addresses (pager, fax, email, host, monitoring station).

A verbose message is especially useful if sent to a pager or email, because it contains descriptive information about the exception. Up to twenty verbose messages can be programmed into a wireless unit. The following verbose message can be sent when Input 3 changes from a Good state to a Bad state:

Example of a verbose message: Anytown Pump Station #243—Pump 1 Fail.

Each input can also be designated if additional information (such as a Date/Time stamp of occurrence or Current Value). For example, if a Time/Date stamp is utilized on the above verbose message, it would show as follows:

Example of a verbose message: Anytown Pump Station #0243—Pump 1 Fail on 3/1/00 11:43 AM.

The above example would then provide the date and time stamp of the occurrence. If the current value was designated, it would show the value as well.

The following events can cause a message to be sent:

1. Input Exceptions (Digital and Analog Inputs);

2. Hardware Exceptions (Hard Reset, Power Loss, Power Restore, Watchdog);

3. Periodic Status (if enabled);

4) Polled (Query for status, parameters, etc.)

Hardware Exceptions will be generated and sent upon error, as well as logged. Messaging events (other than Hardware exceptions) will only be sent if configured to do so. Events can be logged only and polled at a later date, if desired.

The wireless unit may come with several options (referred to as modules) which provide specialized features not found in the base wireless unit. Specific functionality for individual applications can also be provided.

AT Emulation Module: An option of the wireless module is to provide Hayes AT command set emulations. This will allow the present invention to replace traditional Land Line Phone Modems and provide instant wireless connectivity. The present invention would provide plug and play replacement of existing modem, emulating Hayes handshaking and protocol methods.

Schedule Control Module: The Schedule Control option allows the scheduling of outputs based on a time schedule. This schedule can be done by seconds, minutes, hours, or exact time (i.e., 4:00 p.m. to 6:15 p.m.). Schedules can be a one-time, or repeating (i.e., every day).

Diurnal Schedule Control Module: Diurnal Schedule Control allows the scheduling of outputs based on Dusk and Dawn algorithms. This can be useful for turning on/off lighting, sprinkler systems, or any other device that relies on Dawn/Dusk algorithms.

Historical Monitoring Module: The Historical Monitoring module allows the monitoring of Inputs based on a time period (i.e., every minute, hour, day or other interval) and stores these values. These values can then be sent at a predetermined time, or polled from the unit.

GPS Module: The GPS module add-on provides GPS monitoring capability.

Dry Contact Input Options: The following are options for the Dry Contact Inputs:

1. Logging—Check this input?

2. Report—Report an Exception, or just log?

3. Fault State—Fault state can be defined as a Logic High (1) or a Logic Low (0).

4. Broadcast Enabled—Send a message upon exception?

5. Cutoff Faults—Number of exceptions in a 24 hour period before reporting exceptions is stopped;

6. Address 1—Address of destination (email, pager, fax, etc.).

7. Address 1 mode—Terse or Verbose.

8. Address 2—Address of destination (email, pager, fax, etc.).

9. Address 2 mode—Terse or Verbose.

10. Address 3—Address of destination (email, pager, fax, etc.).

11. Address 3 mode—Terse or Verbose.

12. Verbose Message to send upon Fault.

13. Verbose Message to send upon Restore.

14. Add Date/Time to Verbose message.

Analog Input Options: The following are options for the Dry Contact Inputs:

1. Logging—Check this input?

2. Report—Report an Exception, or just log?

3. Fault State—Fault state can be defined as a Logic High (1) or a Logic Low (0).

4. Broadcast Enabled—Send a message upon Exception?

5. Cutoff Faults—Number of Exceptions in a 24 hour period before reporting Exceptions is stopped.

6. Lower Threshold—Value of Lower Threshold. If below, Exception message is created.

7. Upper Threshold—Value of Upper Threshold. If above, Exception message is created.

8. Percent Tolerance—Percent above “calibrated” value to auto generate upper and lower thresholds.

9. Address 1—Address of destination (email, pager, fax, etc.).

10. Address 1 mode—Terse or Verbose.

11. Address 2—Address of destination (email, pager, fax, etc.).

12. Address 2 mode—Terse or Verbose.

13. Address 3—Address of destination (email, pager, fax, etc.)

14. Address 3 mode—Terse or Verbose.

15. Verbose Message to Send upon Fault.

16. Verbose Message to send upon Restore.

17. Show Date/Time in Verbose message.

18. Show Analog Value in Verbose message.

The following description relates more particularly to FIGS. 3-6, and how the databus communicator can operate within a telemetry system. In particular, the present invention provides for databus communicators which use a CAN-system communication protocol between a stationary module and a vehicle.

Overview:

The Controller Area Network (the CANbus) is a serial data communications bus for real-time applications. CAN operates at data rates of up to 1 Megabit per second and has excellent error detection and confinement capabilities.

CAN was originally developed by the German company Robert Bosch for use in the car industry to provide a cost-effective communications bus for in-car electronics and as an alternative to expensive and cumbersome wiring looms. Now, because of its proven reliability and robustness, CAN is being used in many other automation and industrial applications.

Low-cost CAN controllers and interface devices are available as off-the-shelf parts from several of the leading semiconductor manufacturers. Custom-built devices and popular microcontrollers with embedded CAN controllers are also available. There are many CAN-related system development packages. Hardware interface cards and easy-to-use software packages provide system designers, builders and maintainers with a wide range of design, monitoring, analysis, and

A physical layer defines the electrical levels and signaling scheme on the CAN bus, the cable impedance and similar things.

There are several different physical layers. ISO 11898 defines a two-wired balanced signaling system. Alternatively, little-used ISO 11519 for lower speed applications defines another two-wire balanced signaling scheme for lower bus speeds. SAE J2411 defines a single-wire layer but the standard has not yet been accepted.

ISO 11898 only specifies a differentially driven two-wire bus line 33 with common return terminated at both ends by resistors R_{T} representing the characteristic impedance of the line as physical medium. In general, the system integrator has the freedom to optimize the bus-line 33 and the type of connector with either electromagnetic compatibility or cost as the defining variable. The cabling solutions range from unshielded twisted-pair lines with cross-sections of 0.25 sq mm to double-shielded lines with cross-sections of about 1.00 sq mm.

A great many CAN transceiver chips are manufactured by Philips. Alternative vendors include Bosch, Siemens, Siliconix and Unitrode. A very common type is the 82C250 tranceiver which implements the physical layer defined by ISO 11898.

The CAN bus uses Non-Return to Zero (NRZ) with bit-stuffing. There are two different signaling states: dominant (logically 0) and recessive (logically 1). One implementation examined had these corresponding to ±7.9 volts for a physical layer using ISO 11898. The modules are connected to the bus in a “wired-and” fashion. If just one node is driving the bus to the dominant state, then the whole bus is in that state, regardless of the number of nodes transmitting a recessive state.

The CAN Network functions as follows.

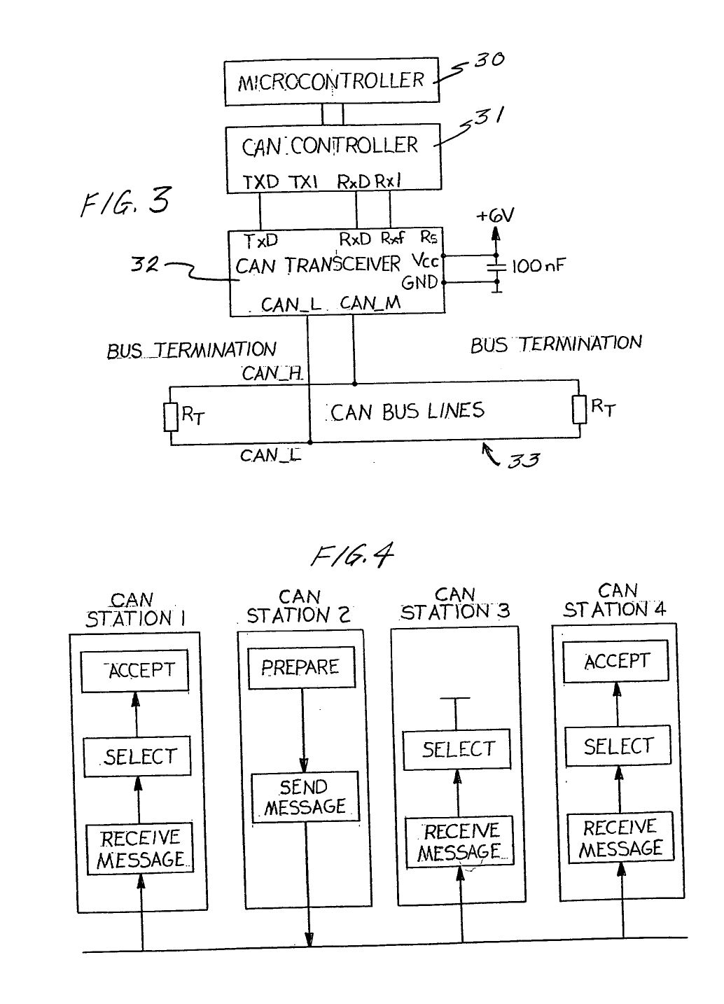

FIG. 4 illustrates broadcast transmissions. When data are transmitted by CAN, no stations are addressed, but instead the content of the message is designated by an identifier that is unique throughout the network. The identifier defines not only the content, but also the priority of the message. This is important for bus allocation when several stations are competing for bus access. If the CPU of a given station wishes to send a message to one or more stations, it passes the data to be transmitted and their identifiers to the assigned CAN chip (“Make ready”). This is al the CPU has to do to initiate data exchange. The message is constructed and transmitted by the CAN chip. As soon as the CAN chip receives the bus allocation (“Send Message”), all other stations on the CAN network become receivers of this message (“Receive Message”). Each station in the CAN network, having received the message correctly, performs an acceptance test to determine wether the data received are relevant for that station (“Select”). If the data are of significance for the station concerned, they are processed (“Accept”), otherwise, they are ignored.

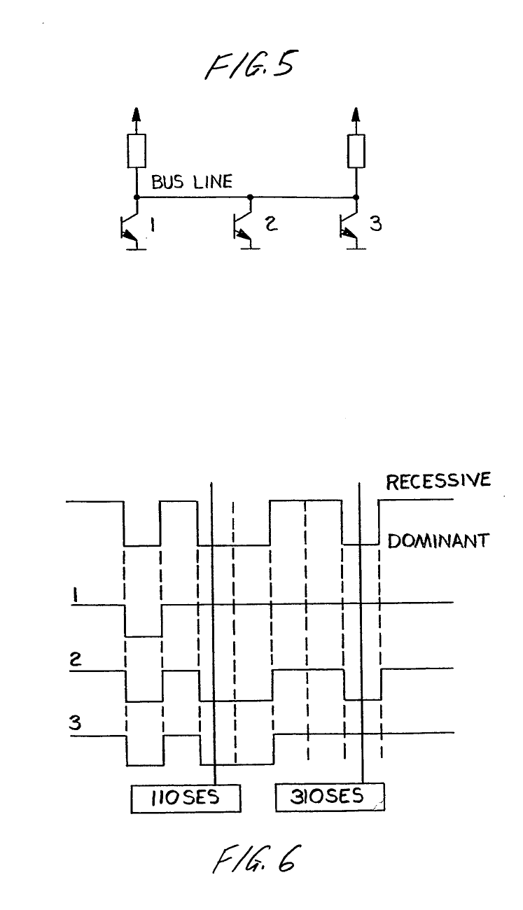

FIGS. 5 and 6 illustrate non-destructive arbitration. Arbitration function is as follows.

For the data to be process in real-time, they must be transmitted rapidly. This not only requires a physical data transfer path with up to 1 Mbit/s but also calls for rapid bus allocation when several stations wish to send messages simultaneously. In real-time processing the urgency of messages to be exchanged over the network can differ greatly. A rapidly changing dimension has to be transmitted more frequently and therefore with less delays than other dimensions which change relatively slowly. The priority at which a message is transmitted compared with another less urgent message is specified by the identifier of the message concerned. The priorities are laid down during system design in the form of corresponding binary values and cannot be changed dynamically. The identifier with the lowest binary number has the highest priority. Bus access conflicts are resolved by bitwise arbitration on the identifiers involved by each station observing the bus level bit for bit. In accordance with the “wired-and” mechanism, by which the dominant stage (logical 0) overwrites the recessive state (logical 1), the competition for bus allocation is lost by all those stations with recessive transmission and dominant observation. All “losers” automatically become receivers of the message with the highest priority and do not re-attempt transmission until the bus is available again.

CAN controllers and interface chips are physically small. They are available as low-cost, off-the-shelf components. They will operate at high, real-time speeds, and in harsh environments. All these properties have lead to CAN being used in a wide range of applications other than the car industry.

Using CAN to network controllers, actuators, sensors, and transducers results in: reduced design time (readily available, multi-sourced components and tools); lower connection costs (lighter, smaller cables); and improved reliability (fewer connections).

The safety-related aspects of using CAN in cars attracted the attention of manufacturers of medical system. Because of the inherent reliability of the data transmission and the stringent safety requirements that need to be built into medical equipment such as X-ray machines, CAN is now used in a range of these systems.

Since CAN based systems are a future standard, the present invention provides a CAN communicator to control, diagnose, and evaluate system operations in automotive applications. Currently, only “high-end” vehicles utilize CAN-based systems, but in the immediate future, auto-makers are transferring from “wired” systems to CAN systems. This is the new standard worldwide for automakers. The present invention takes this standard and develops a communicator which will allow the user to control the CAN systems from remote locations via email, PDA, or other devices. This permits the user to control, diagnose, and interact with a vehicle's electrical system from anywhere. This new communicator can be designed to function in any type of system, integration, from security to telematics.

There have been described hereinabove only some unique and novel embodiments of the preferred invention which can be implemented in many different ways. It should be understood that many changes, modifications, variations, and other uses and applications will become apparent to those persons skilled in this particular area of technology and to others after having been exposed to the present patent application.

Any and all such changes, modifications, variations, and other uses and applications which do not depart from the spirit and scope of the present invention are therefore covered by and embraced within the present invention and the patent claims set forth hereinbelow.

1. A databus communicator which uses a Controller Area Network system communication protocol between a stationary module and a vehicle, comprising, in combination:
a wireless control device for multiple networks which allows communication, commands, and readings to be sent and received via telephone, internet, e-mail, or any text-compatible device or network;
a main circuit board/two-way paging device;
said databus communicator being operably connected to said main circuit board/two-way paging device;
a two-way paging antenna operably connected to said main circuit board/two-way paging device;
a satellite modem/satellite communication circuit board operably connected to said main circuit board/two-way paging device;
a satellite antenna operably connected to said satellite modem/satellite communication circuit board;
a global positioning chip set operably connected to said main circuit board/two-way paging device;
a global positioning antenna operably connected to said global positioning chip set;
a voltage regulation circuit board operably connected to said main circuit board/two-way paging device;
a microprocessor board/network carrier roam control unit operably connected to said main circuit board/two-way paging device;
first means for determining the best way to send data over various network types, such as two-way paging, one-way paging, CDMA, GSM, TDMA, satellite, or analog.

2. A databus communicator according to claim 1, wherein:
said wireless control device acts as a gateway between said wireless networks and a circuit it is programmed to command, read, or communicate with.

3. A databus communicator according to claim 1, wherein:
said wireless control device is used to guide said vehicle along a highway system, whereby a user can input a destination, and said device via software programming will be able to steer, brake and accelerate said vehicle automatically, while inputting and analyzing data from said vehicle's electronic control module as to the condition of said vehicle's mechanical and electrical functions.

4. A databus communicator according to claim 2, wherein:
said wireless control device is used to guide said vehicle along a highway system, whereby a user can input a destination, and said device via software programming will be able to steer, brake and accelerate said vehicle automatically, while inputting and analyzing data from said vehicle's electronic control module as to the condition of said vehicle's mechanical and electrical functions.

5. A databus communicator which uses a Controller Area Network system communication protocol between a stationary module and a vehicle, comprising, in combination:
a wireless control device for multiple networks which allows communication, commands, and readings to be sent and received via telephone, internet, e-mail or any text-compatible device or network;
a motherboard having a dataport;
a network roam module operably connected to said dataport or said motherboard;
a plurality of chip sets, including CDMA, TDMA, GSM, and analog cellular operably connected to said network roam module;
a satellite modem operably connected to said dataport;
a satellite antenna operably connected to said satellite modem;
network antennas, operably connected to said dataport;
a GPS chip set operably connected to said motherboard;
a GPS antenna operably connected to said GPS chip set;
said databus communicator being operably connected to said motherboard;
an external voltage regulating circuit operably connected to said motherboard;
an external flash memory and microprocessor operably connected to said motherboard; and
means for determining the best way to send data over a plurality of network types including two-way paging, one-way paging, CDMA, GSM, TDMA, satellite or analog.

6. A databus communicator according to claim 5, wherein:
said wireless control device acts as a gateway between said wireless networks and a circuit it is programmed to command, read, or communicate with.

7. A databus communicator according to claim 5, wherein:
said wireless control device is used to guide said vehicle along a highway system, whereby a user can input a destination, and said device via software programming will be able to steer, brake and accelerate said vehicle automatically, while inputting and analyzing data from said vehicle's electronic control module as to the condition of said vehicle's mechanical and electrical functions

8. A databus communicator according to claim 6, wherein:
said wireless control device is used to guide said vehicle along a highway system, whereby a user can input a destination, and said device via software programming will be able to steer, brake and accelerate said vehicle automatically, while inputting and analyzing data from said vehicle's electronic control module as to the condition of said vehicle's mechanical and electrical functions

9. A databus communicator which uses a Controller Area Network system communication protocol between a stationary module and a vehicle, comprising, in combination:
a wireless control device for tracking said vehicle;
a GPS receiver;
a satellite transmitter operably connected to said GPS receiver for transmitting data from said vehicle through satellites;
a microcontroller operably connected to said GPS receiver and to said satellite transmitter;
a source of electrical power operably connected to said GPS receiver, said satellite transmitter, and said microcontroller;
said database communicator being operably connected with said microcontroller;
attachment means for installing said wireless control device on said vehicle;
first means for sensing predetermined conditions relating to said vehicle; and
said first means being operably connected to said satellite transmitter and said microcontroller.

10. A databus communicator according to claim 9, wherein:
said wireless control device acts as a gateway between said wireless networks and a circuit it is programmed to command, read, or communicate with.

11. A databus communicator according to claim 9, wherein:
said wireless control device is used to guide said vehicle along a highway system, whereby a user can input a destination, and said device via software programming will be able to steer, brake and accelerate said vehicle automatically, while inputting and analyzing data from said vehicle's electronic control module as to the condition of said vehicle's mechanical and electrical functions.

12. A databus communicator according to claim 10, wherein:
said wireless control device is used to guide said vehicle along a highway system, whereby a user can input a destination, and said device via software programming will be able to steer, brake and accelerate said vehicle automatically, while inputting and analyzing data from said vehicle's electronic control module as to the condition of said vehicle's mechanical and electrical functions.
